(19) United States
(12) Patent Application Publication
(10) Pub. No.: US 2010/0037170 A1
(43) Pub. Date: Feb. 11, 2010

(54) SELF-IMPROVEMENT SYSTEMS AND METHODS

(75) Inventor: Brent Poole, Seattle, WA (US)

Correspondence Address: BLACK LOWE & GRAHAM, PLLC, 701 FIFTH AVENUE, SUITE 4800, SEATTLE, WA, 98104, US

(73) Assignee: MINDBLOOM, INC., Seattle, WA (US)

(21) Appl. No.: 12/491,035

(22) Filed: Jun. 24, 2009

Related U.S. Application Data
(60) Provisional application No. 61/075,293, filed on Jun. 24, 2008.

(51) Int. Cl. G06F 3/048

(52) U.S. Cl. 715/772

(57) ABSTRACT

A system includes at least one electronic device configured to provide to a first computer a graphical user interface enabling a user of the first computer to establish and monitor progress towards a personal objective, and receive data input from the user.

### PRIORITY CLAIM

The present application claims priority from U.S. Provisional Application No. 61/075,293 filed Jun. 24, 2008, which is herein incorporated by reference.

### BACKGROUND OF THE INVENTION

A human lifetime consists of people, relationships, activities, goals, interactions, hobbies, aspirations and beliefs. As people pursue these endeavors, they utilize a wide variety of tools, systems, teachers and techniques. From Weight Watchers to Tony Robbins to Franklin-Covey to Nike to The Secret, millions of dollars and hours are spent in the pursuit of growth and self improvement.

### BRIEF DESCRIPTION OF THE DRAWING

FIG. 1 is a screenshot illustrating a computer-implemented process according to an embodiment;

FIG. 2 is a screenshot illustrating a computer-implemented process according to an embodiment;

FIG. 3 is a screenshot illustrating a computer-implemented process according to an embodiment;

FIG. 4 is a screenshot illustrating a computer-implemented process according to an embodiment;

FIG. 5 is a screenshot illustrating a computer-implemented process according to an embodiment;

FIG. 6 is a screenshot illustrating a computer-implemented process according to an embodiment;

FIG. 7 is a screenshot illustrating a computer-implemented process according to an embodiment;

FIG. 8 is a screenshot illustrating a computer-implemented process according to an embodiment;

FIG. 9 is a screenshot illustrating a computer-implemented process according to an embodiment;

FIG. 10 is a screenshot illustrating a computer-implemented process according to an embodiment;

FIG. 11 is a screenshot illustrating a computer-implemented process according to an embodiment;

FIG. 12 is a screenshot illustrating a computer-implemented process according to an embodiment;

FIG. 13 is a screenshot illustrating a computer-implemented process according to an embodiment;

FIG. 14 is a screenshot illustrating a computer-implemented process according to an embodiment;

FIG. 15 is a screenshot illustrating a computer-implemented process according to an embodiment;

FIG. 16 is a screenshot illustrating a computer-implemented process according to an embodiment;

FIG. 17 is a screenshot illustrating a computer-implemented process according to an embodiment;

FIG. 18 is a screenshot illustrating a computer-implemented process according to an embodiment;

FIG. 19 is a screenshot illustrating a computer-implemented process according to an embodiment;

FIG. 20 is a screenshot illustrating a computer-implemented process according to an embodiment;

FIG. 21 is a screenshot illustrating a computer-implemented process according to an embodiment;

FIG. 22 is a screenshot illustrating a computer-implemented process according to an embodiment;

FIG. 23 is a screenshot illustrating a computer-implemented process according to an embodiment;

FIG. 24 is a screenshot illustrating a computer-implemented process according to an embodiment;

FIG. 25 is a screenshot illustrating a computer-implemented process according to an embodiment;

FIG. 26 is a screenshot illustrating a computer-implemented process according to an embodiment;

FIG. 27 is a screenshot illustrating a computer-implemented process according to an embodiment;

FIG. 28 is a schematic view of an exemplary operating environment in which an embodiment of the invention can be implemented; and

FIG. 29 is a functional block diagram of an exemplary operating environment in which an embodiment of the invention can be implemented.

### DETAILED DESCRIPTION OF THE PREFERRED EMBODIMENT

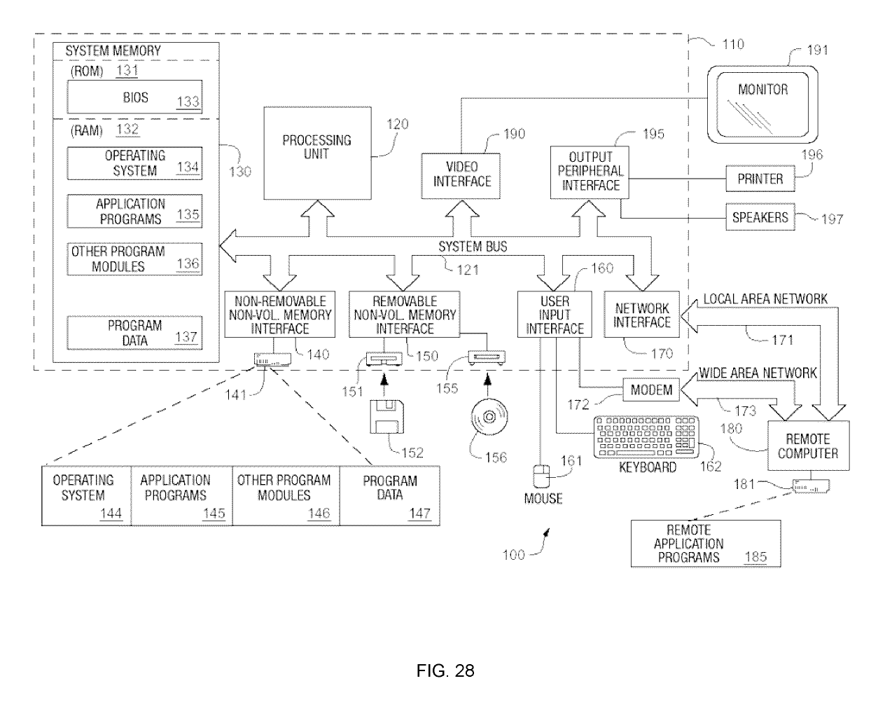

FIG. 28 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 28, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 28 illustrates operating system 134, application programs 135, other program modules 136, and program data 137.

The computer 110 may also include other removable/non-removable, volatile/nonvolatile computer storage media. By way of example only, FIG. 28 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 28, provide storage of computer readable instructions, data structures, program modules and other data for the computer 110. In FIG. 28, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 28. The logical connections depicted in FIG. 28 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 28 illustrates remote application programs 185 as residing on memory device 181. It will be appreciated that the network connections shown are exemplary and other means of establishing a communications link between the computers may be used.

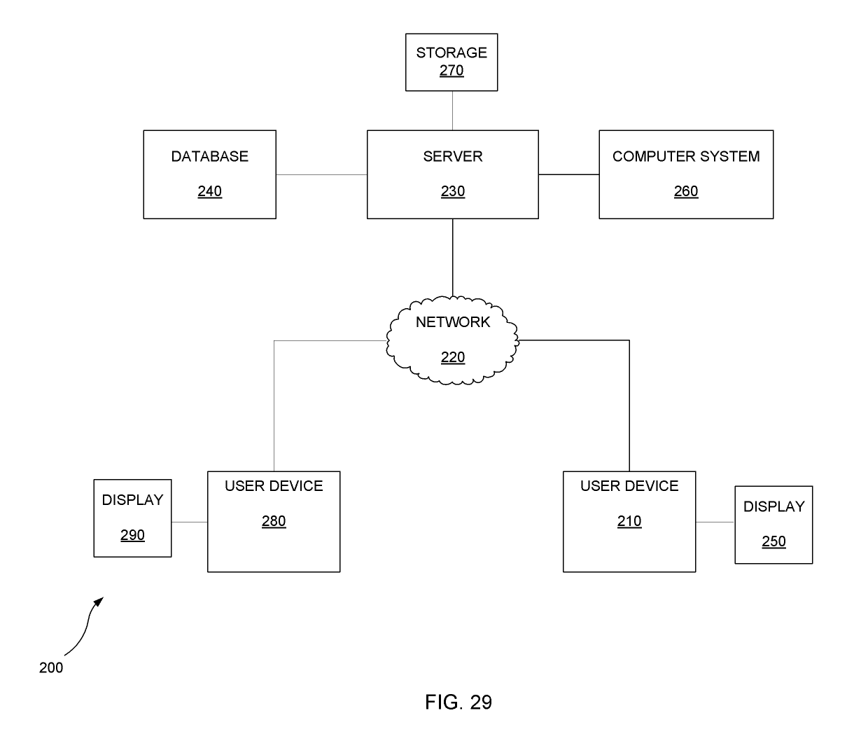

Referring now to FIG. 29, an embodiment of the present invention can be described in the context of an exemplary computer network system 200 as illustrated. System 200 includes electronic user devices 210, 280, such as personal computers or workstations, that are linked via a communication medium, such as a network 220 (e.g. the Internet), to an electronic device or system, such as a server 230. The server 230 may further be coupled, or otherwise have access, to a database 240, electronic storage 270 and a computer system 260. Although the embodiment illustrated in FIG. 29 includes one server 230 coupled to two user devices 210, 280 via the network 220, it should be recognized that embodiments of the invention may be implemented using two or more such user devices coupled to one or more such servers.

In an embodiment, each of the user devices 210, 280 and server 230 may include all or fewer than all of the features associated with the computer 110 illustrated in and discussed with reference to FIG. 28. User devices 210, 280 include or are otherwise coupled to a computer screen or display 250, 290, respectively. User devices 210, 280 can be used for various purposes including both network- and local-computing processes.

The user devices 210, 280 are linked via the network 220 to server 230 so that computer programs, such as, for example, a browser or other applications, running on the user devices 210, 280 can cooperate in two-way communication with server 230. Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

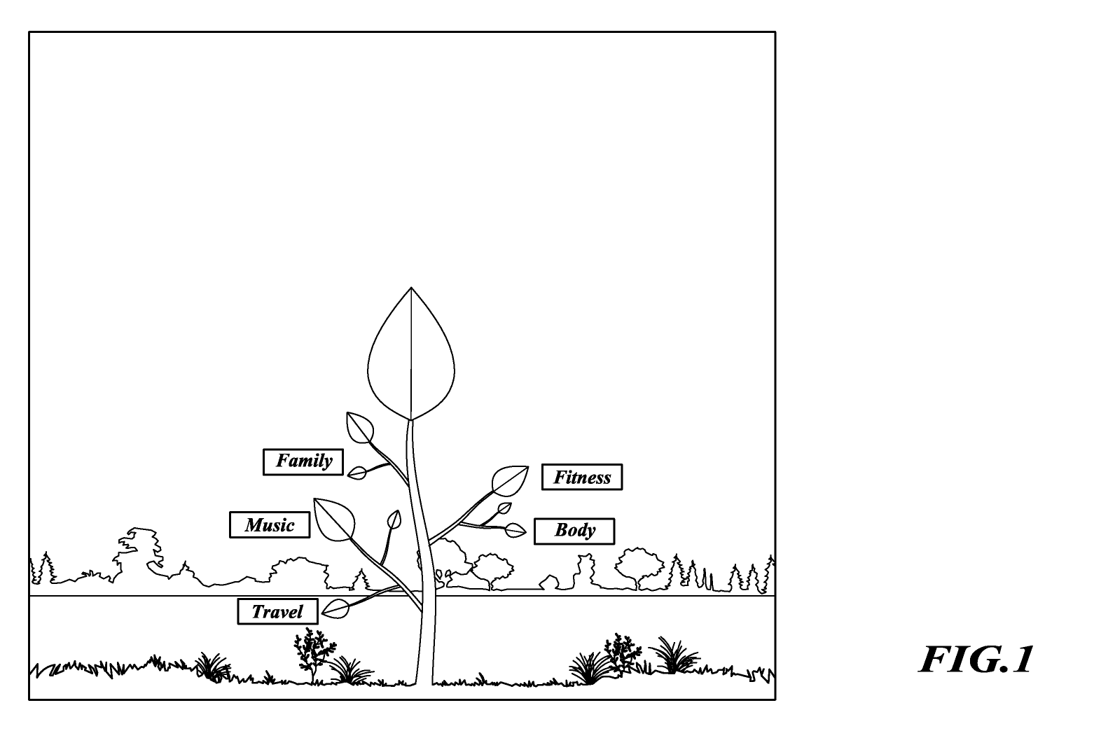

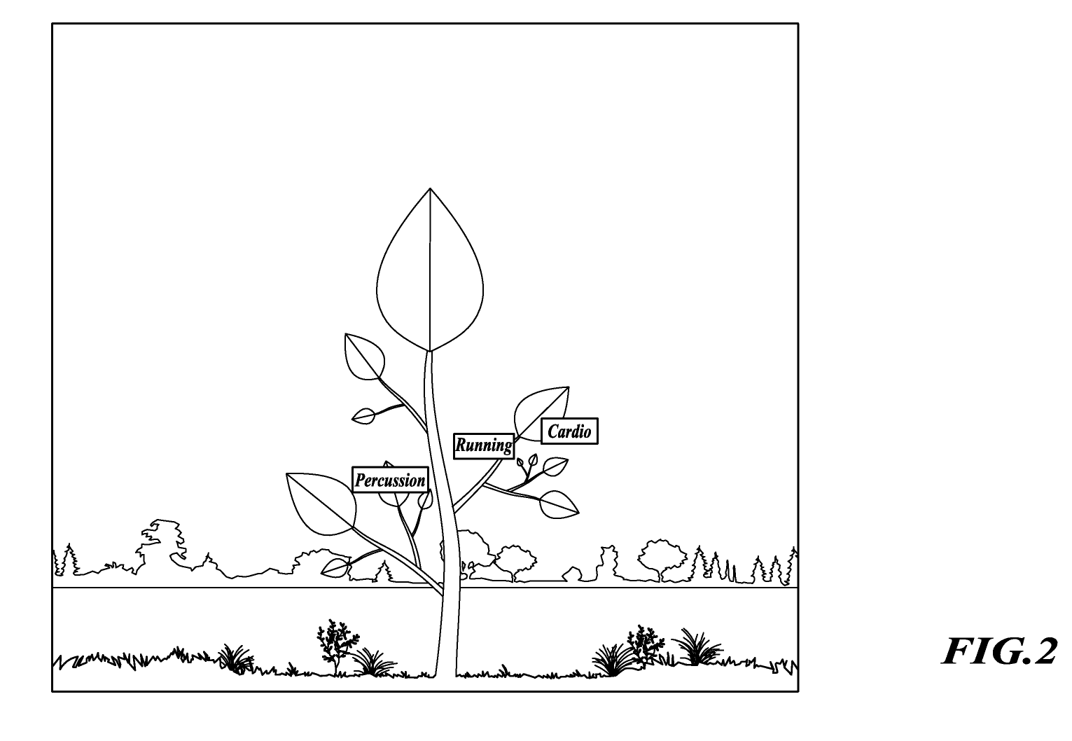

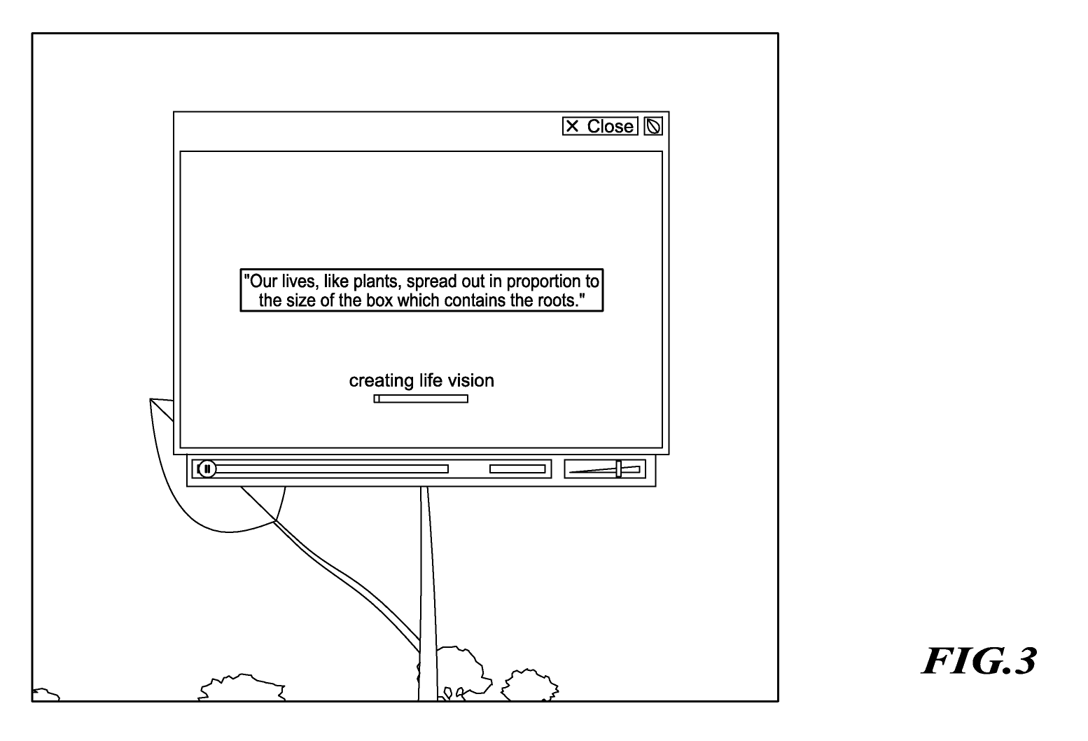

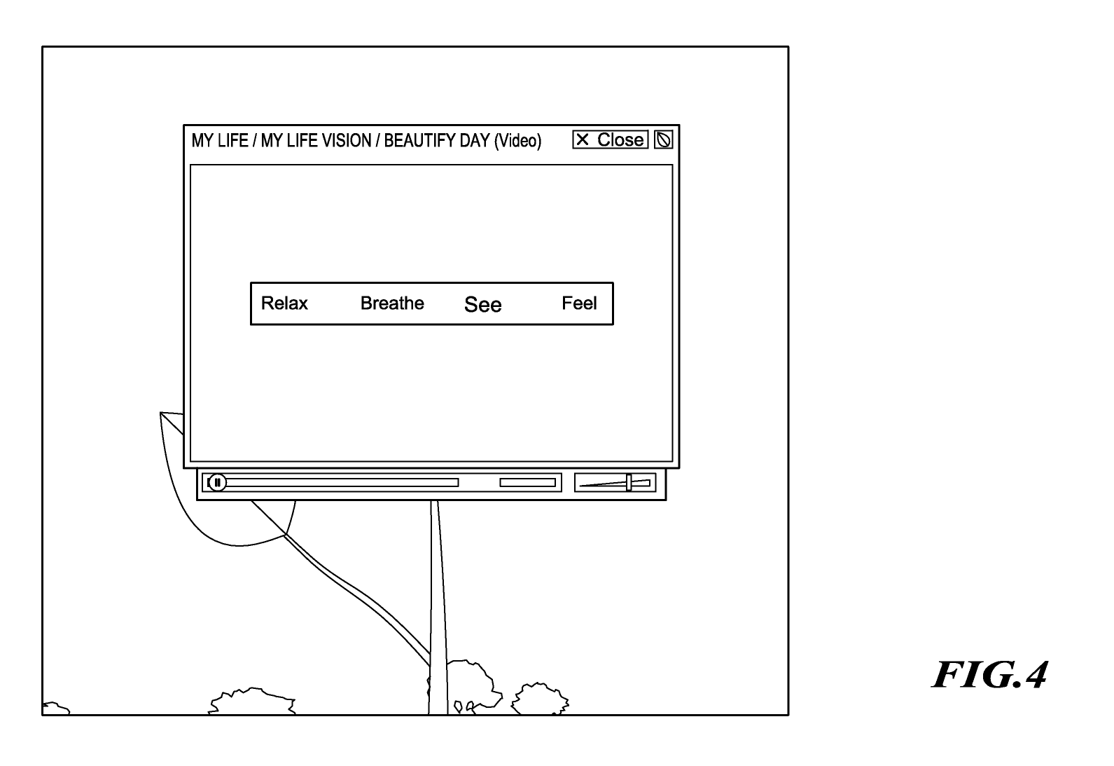

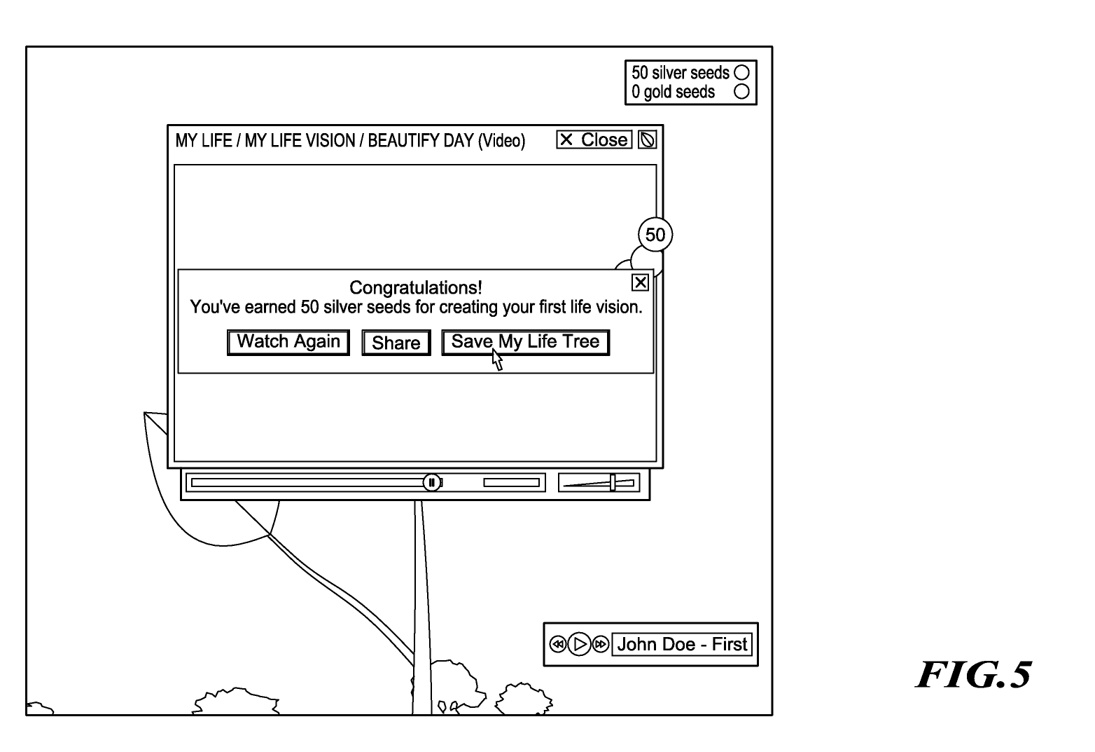

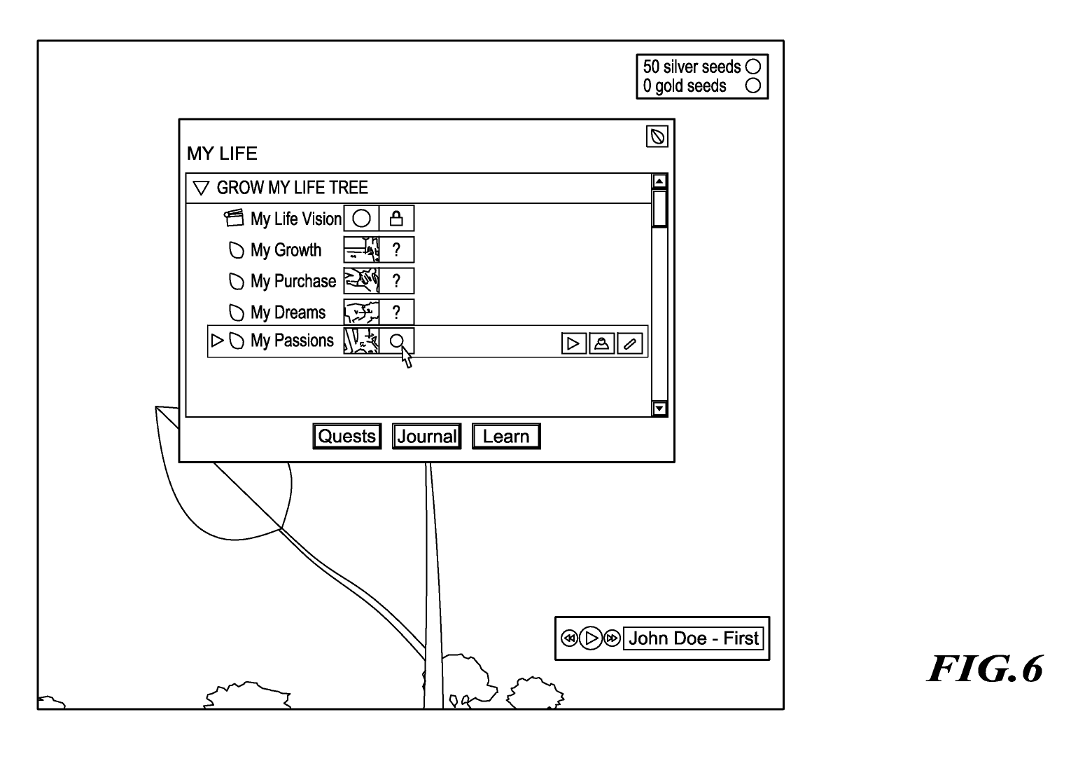

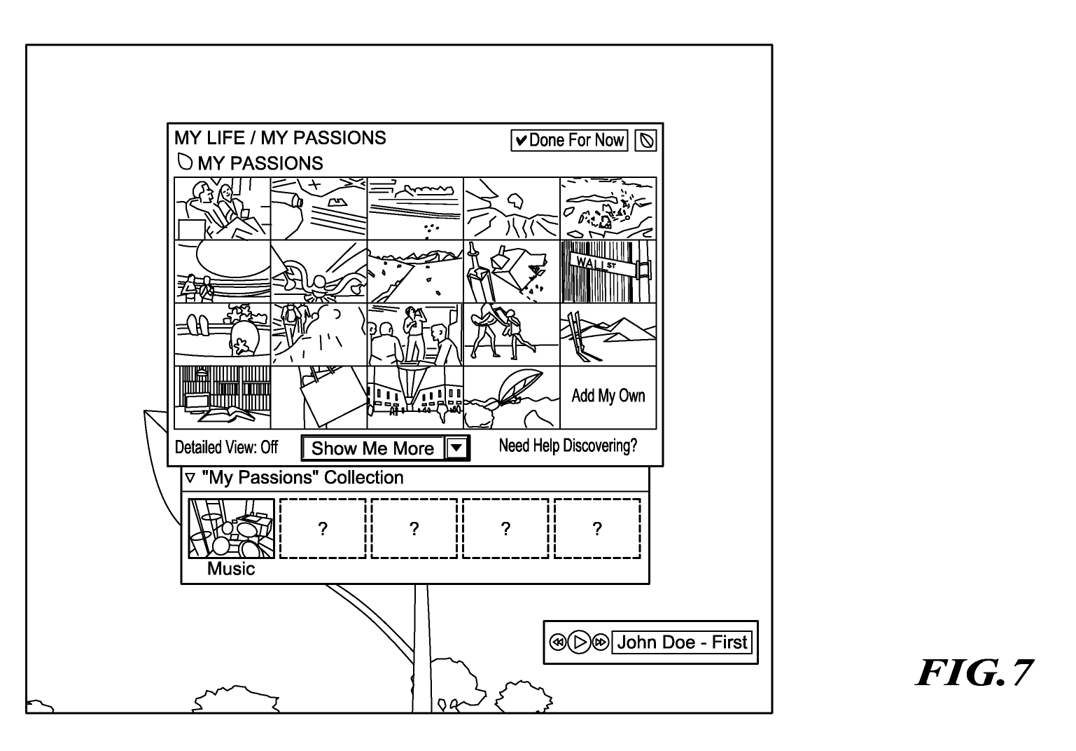

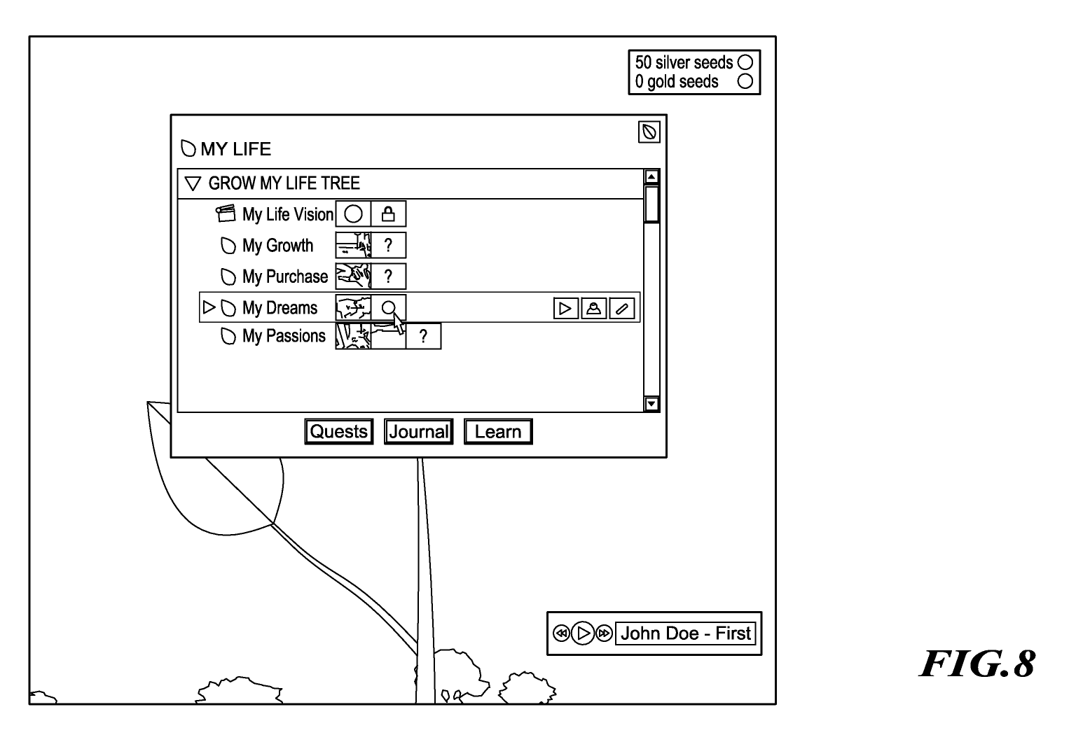

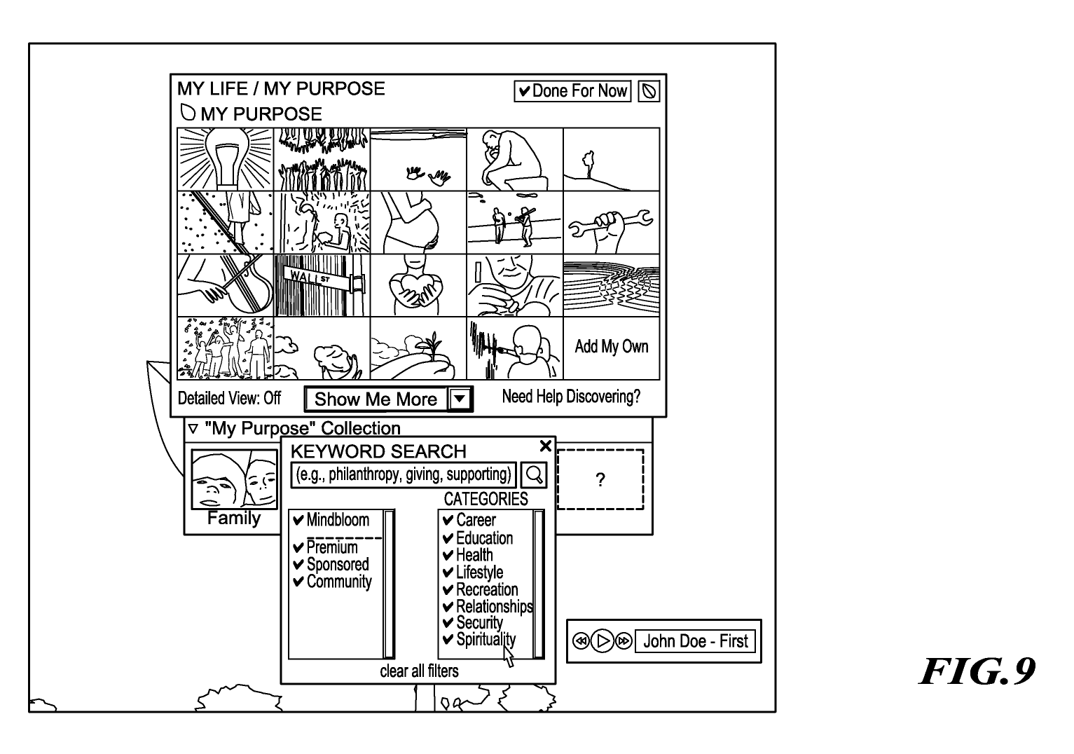

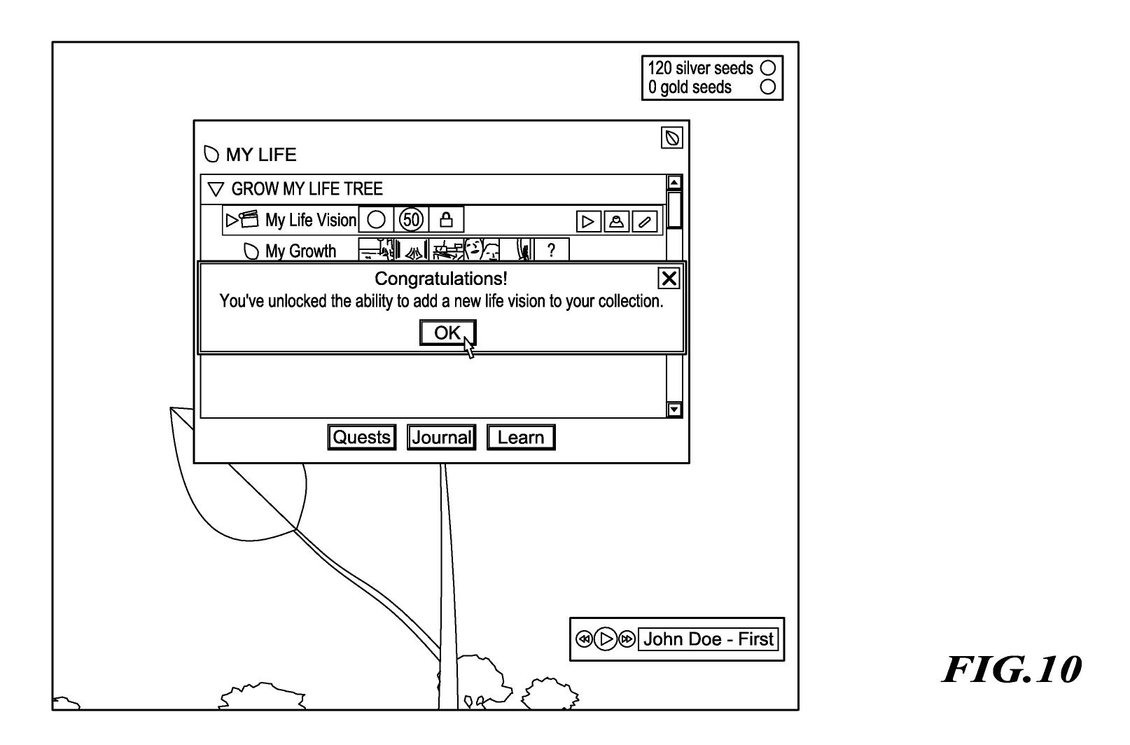

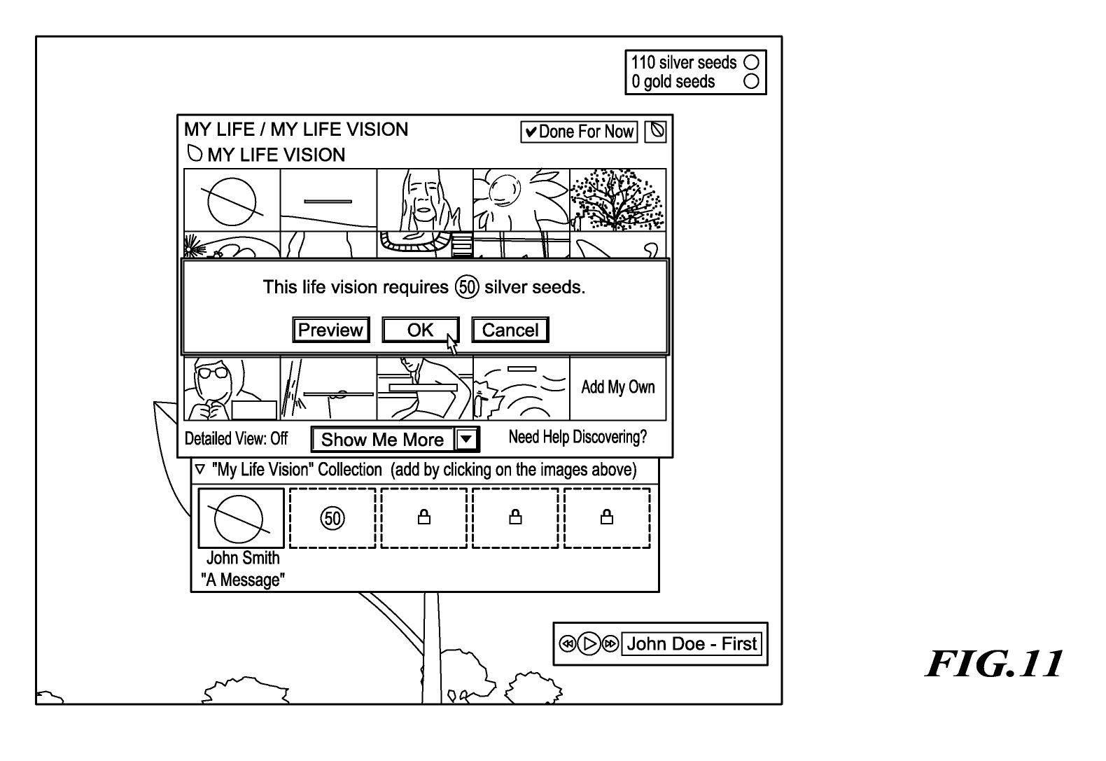

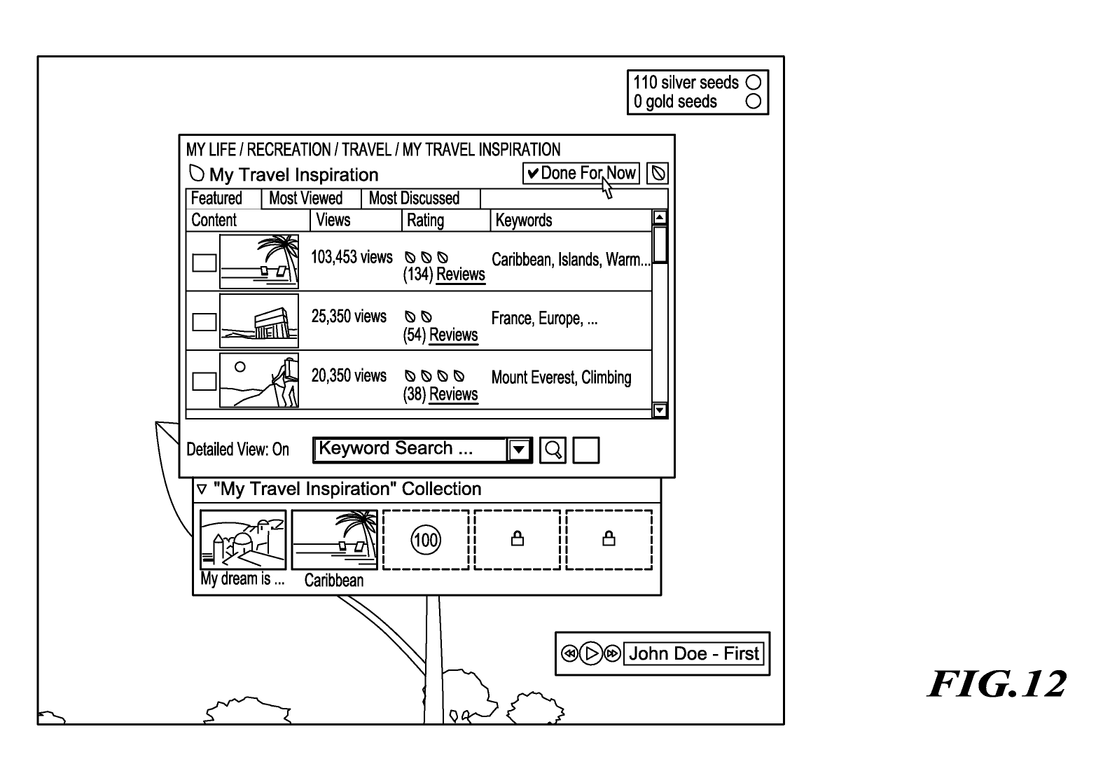

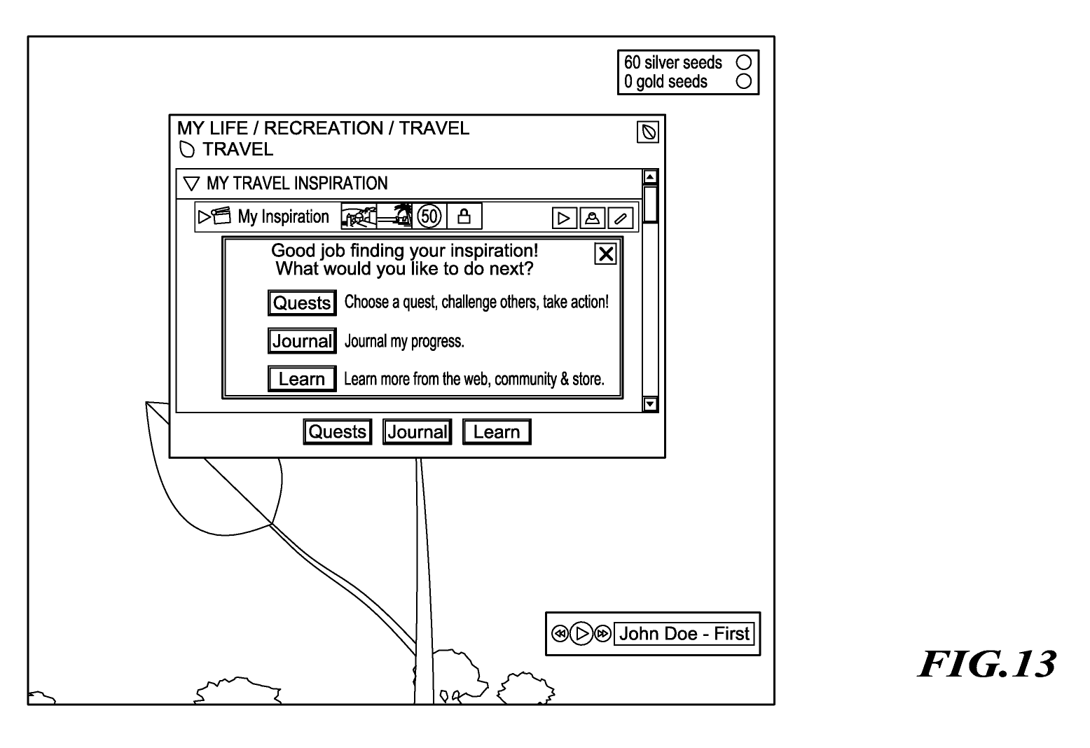

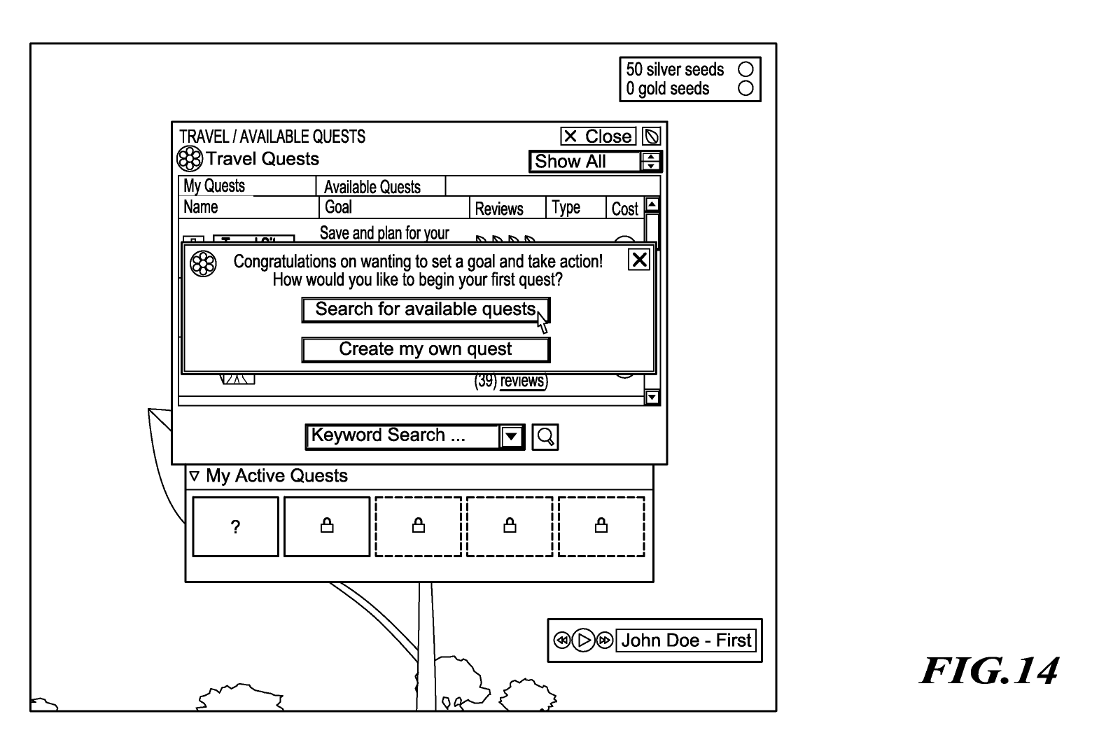

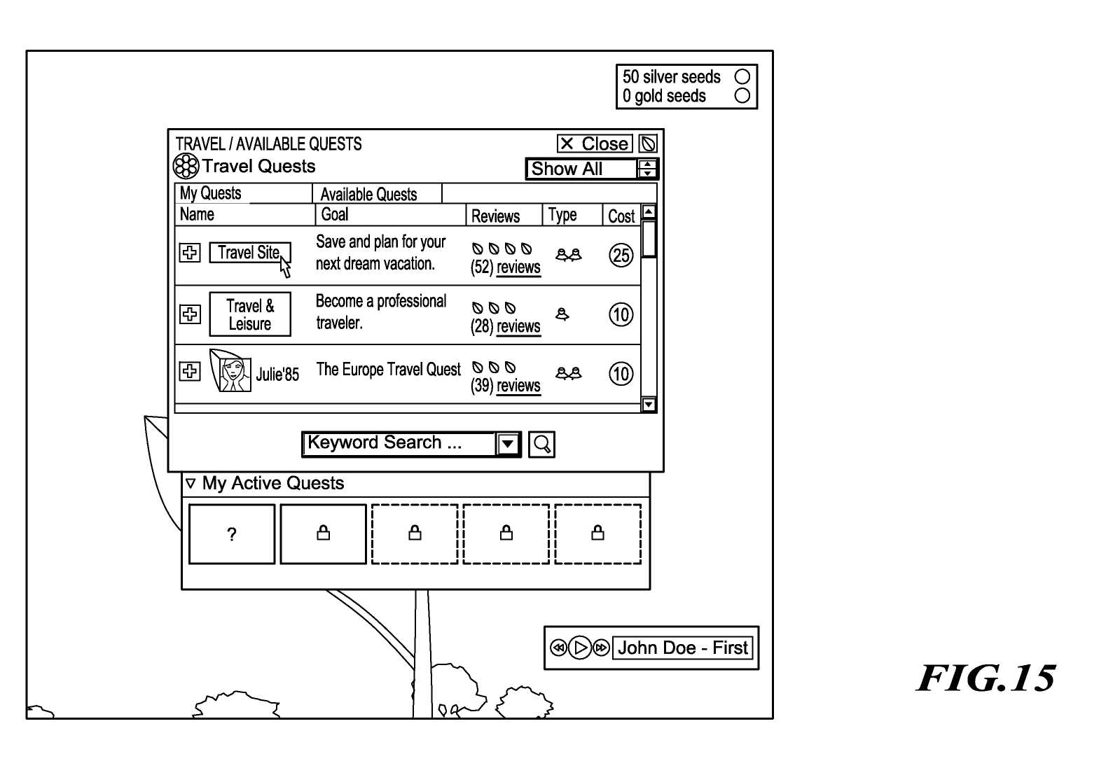

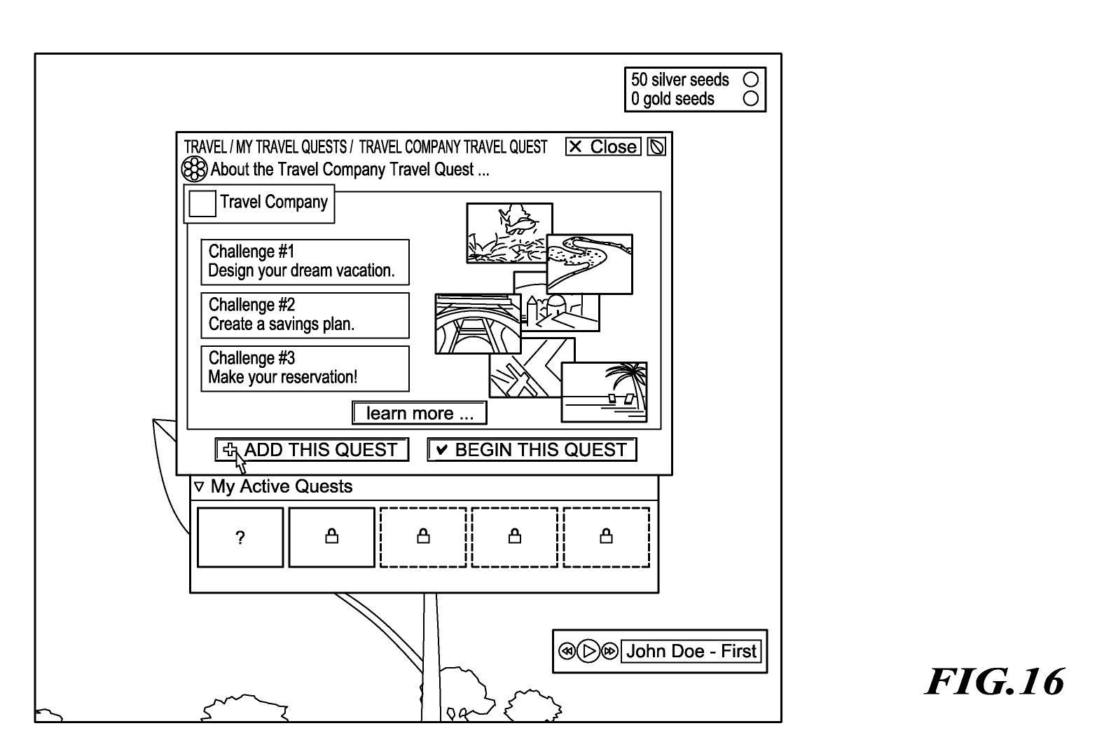

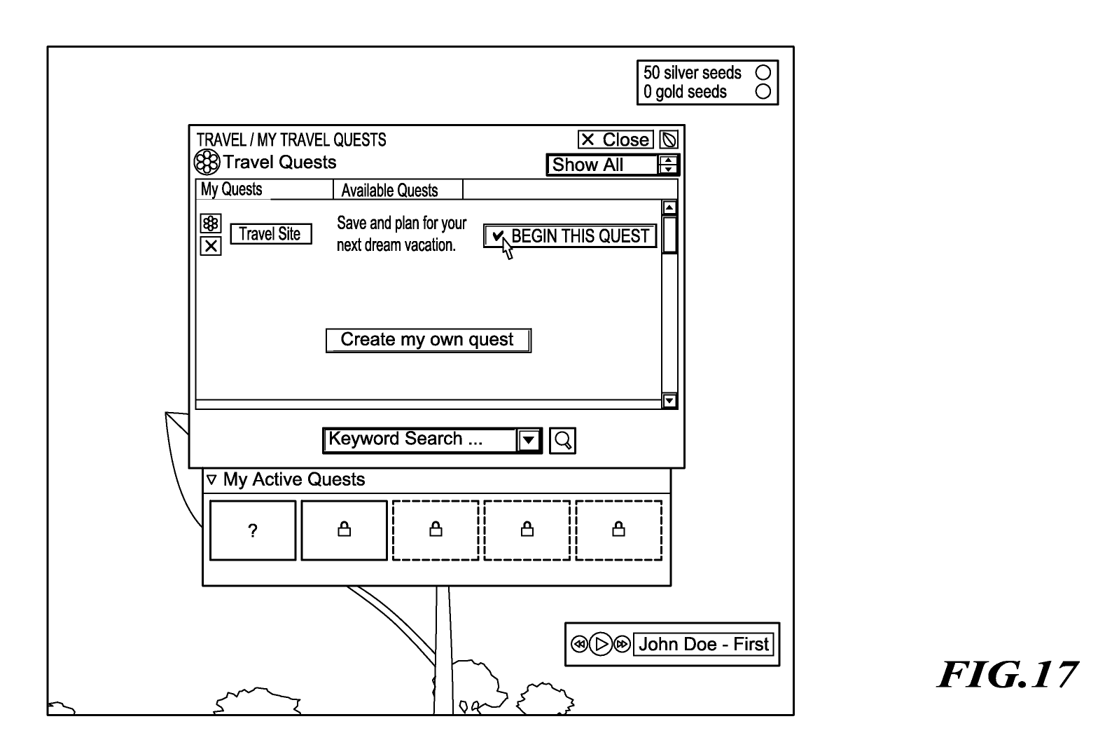

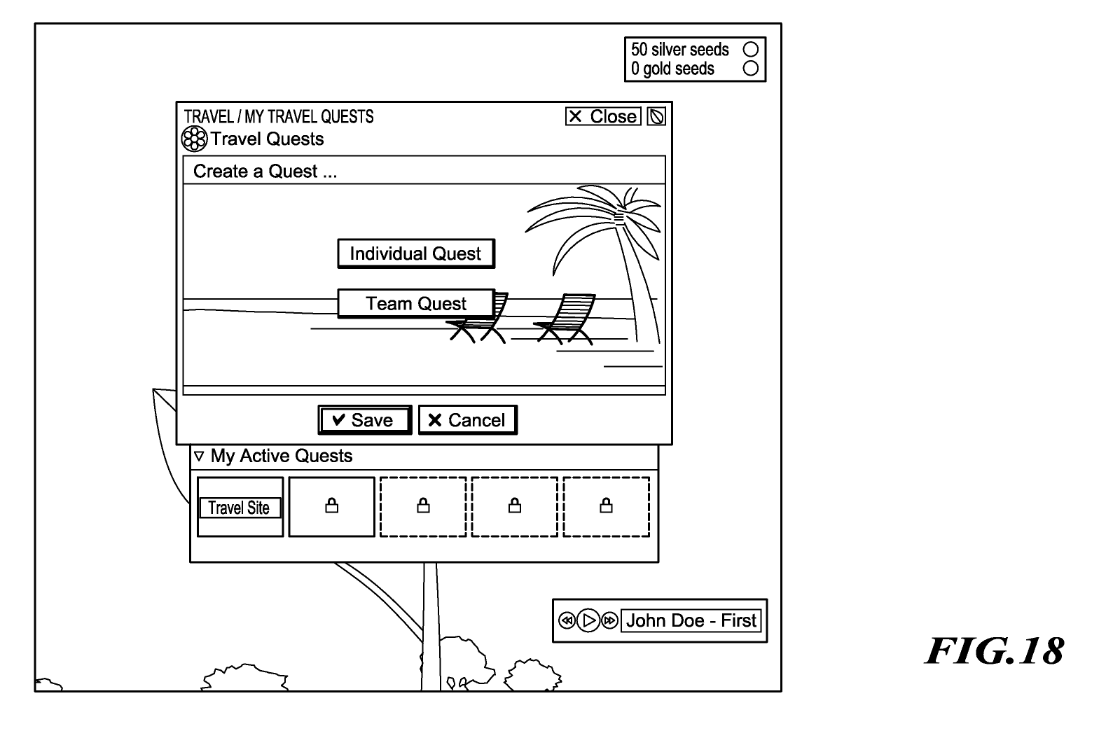

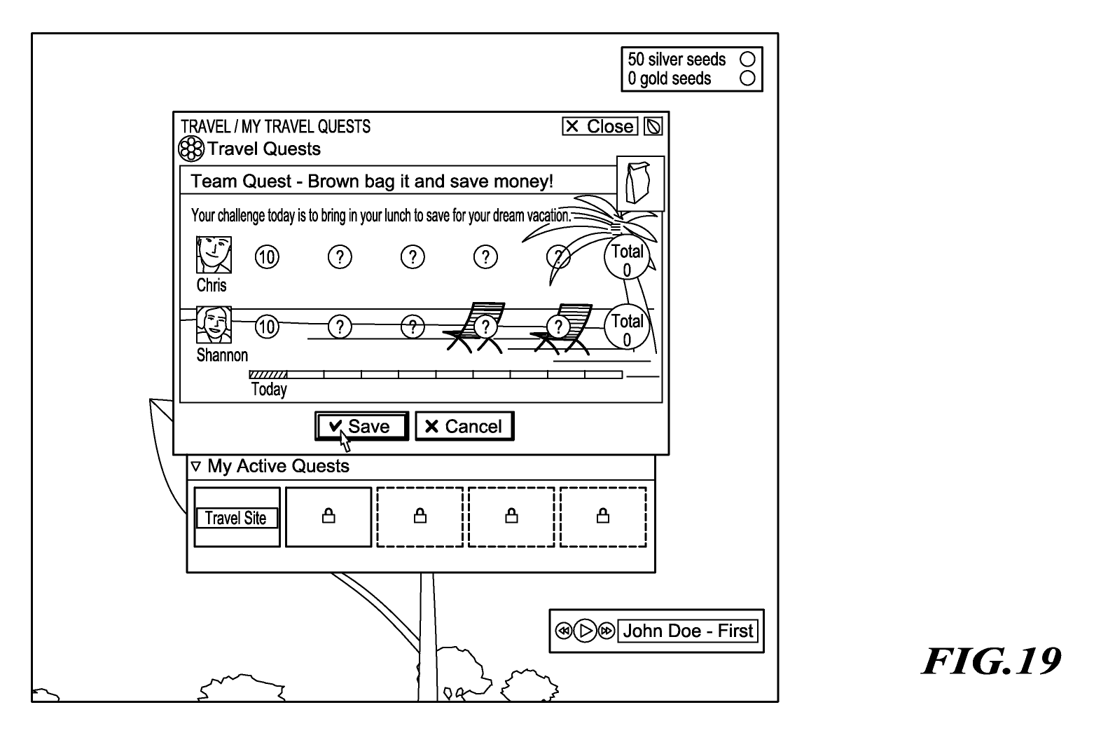

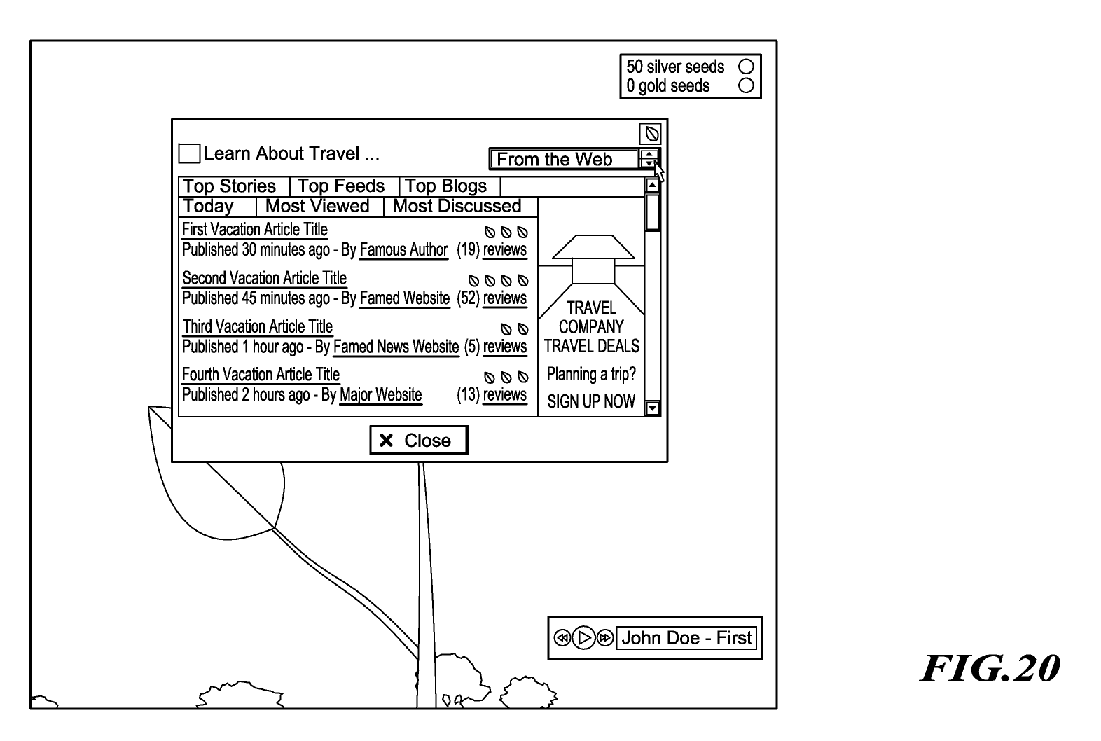

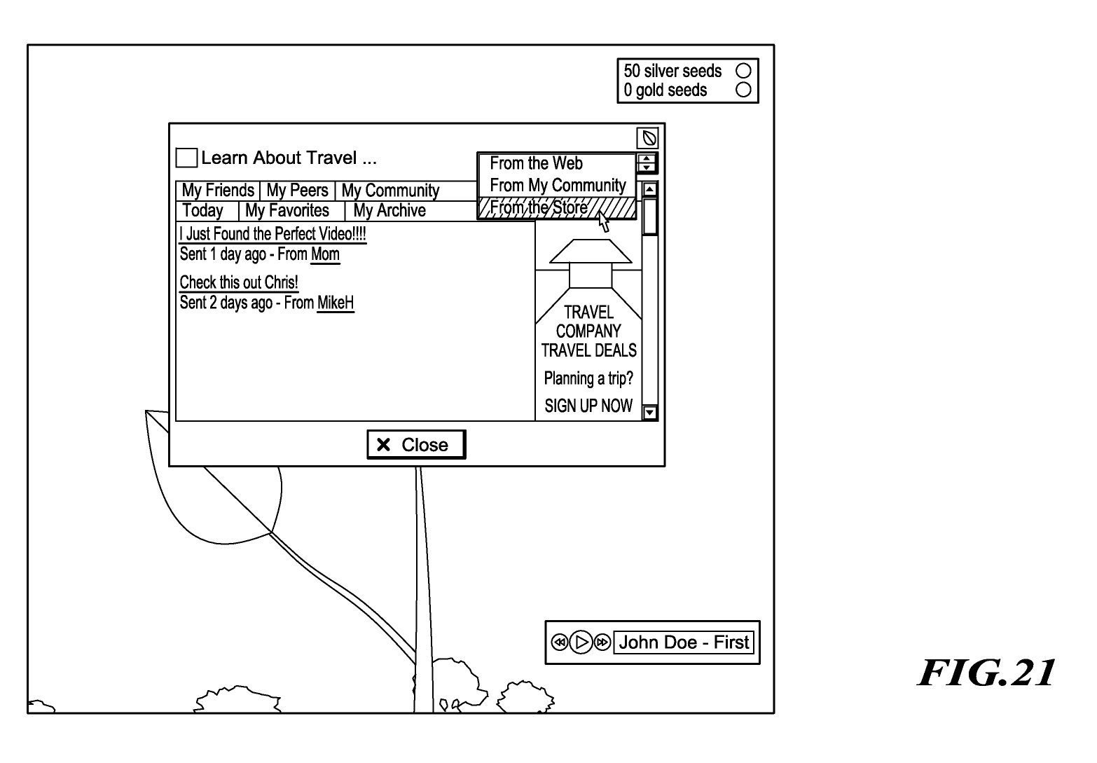

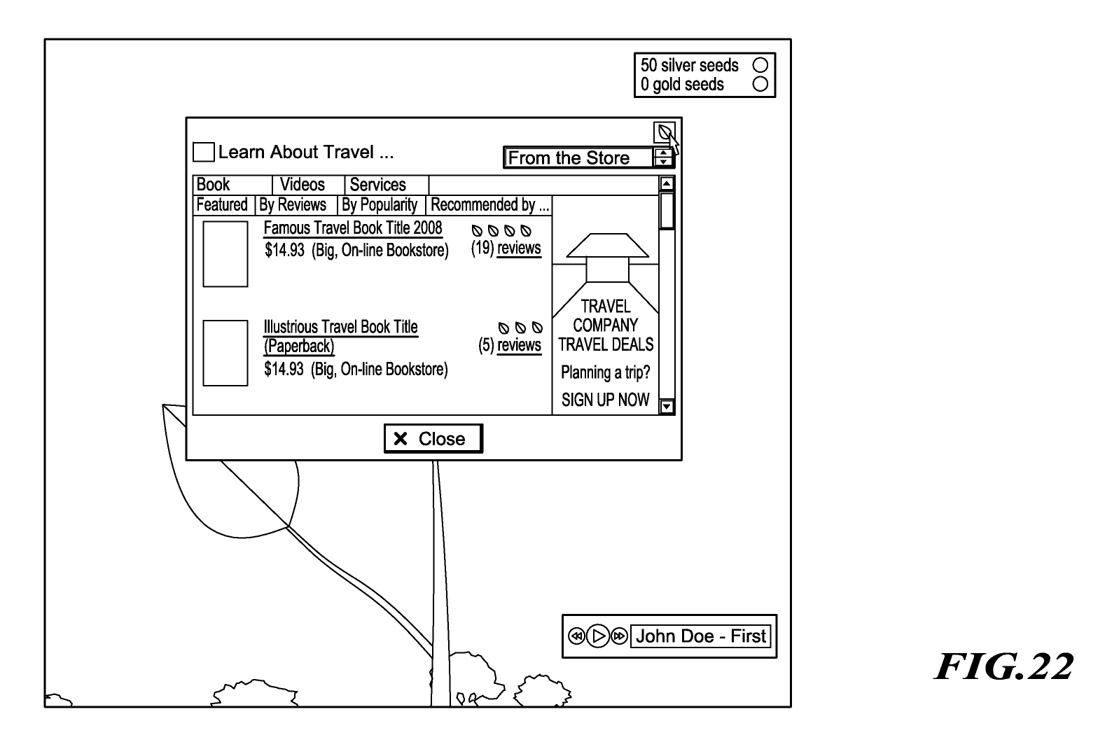

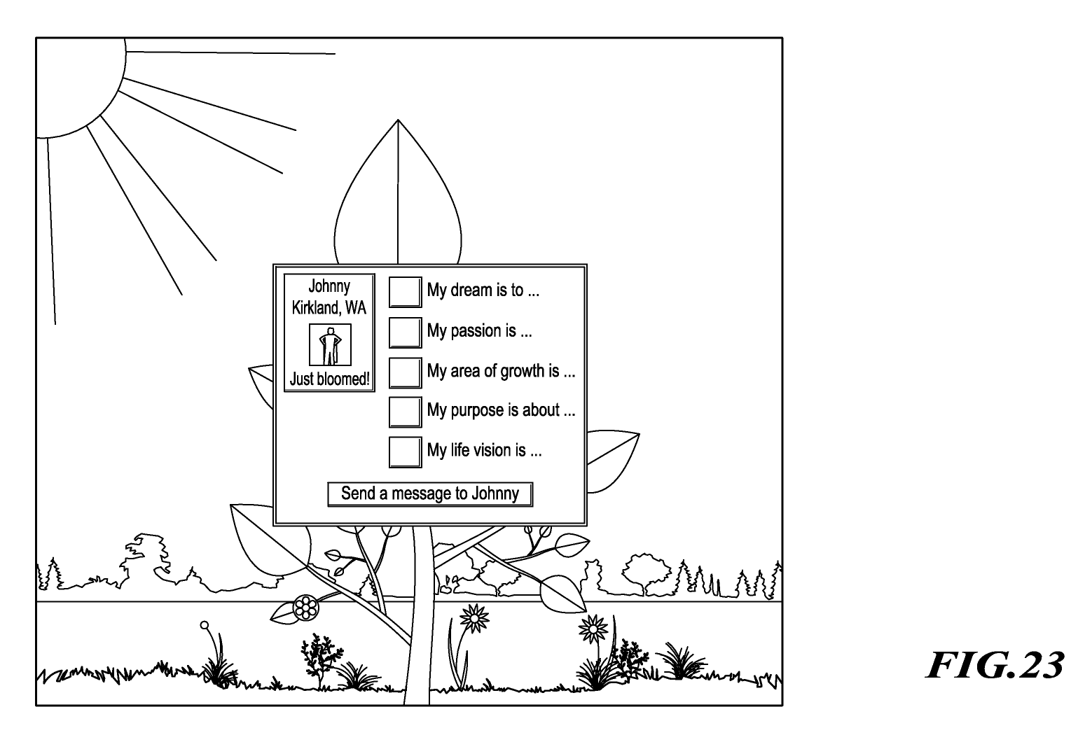

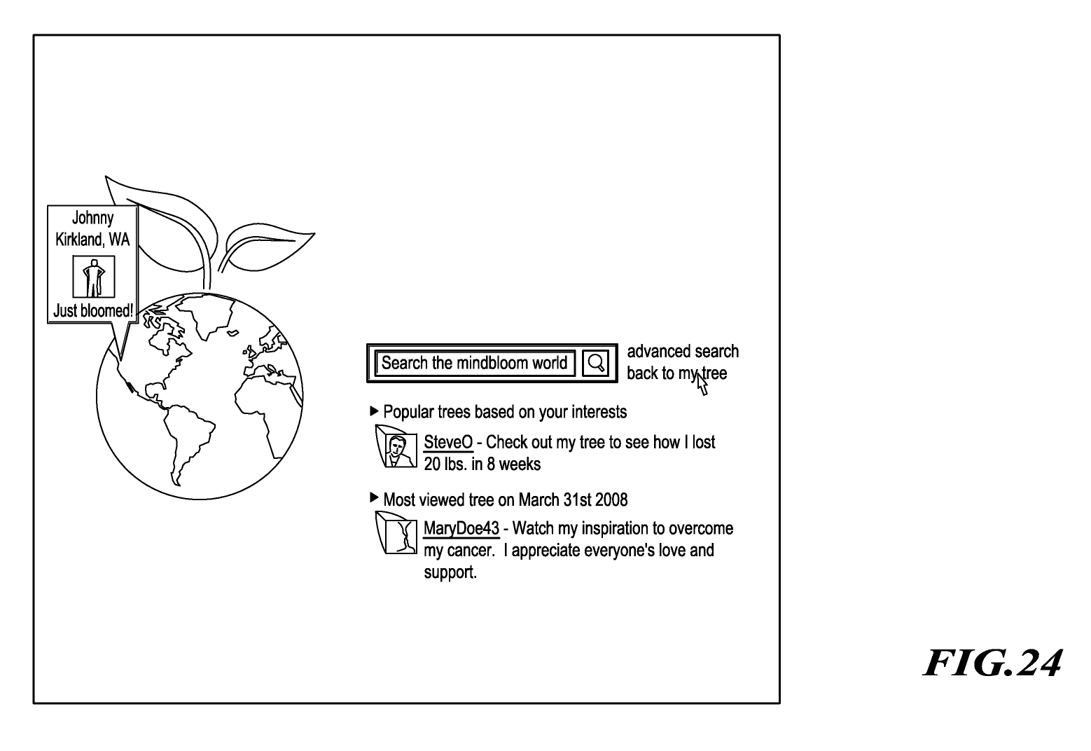

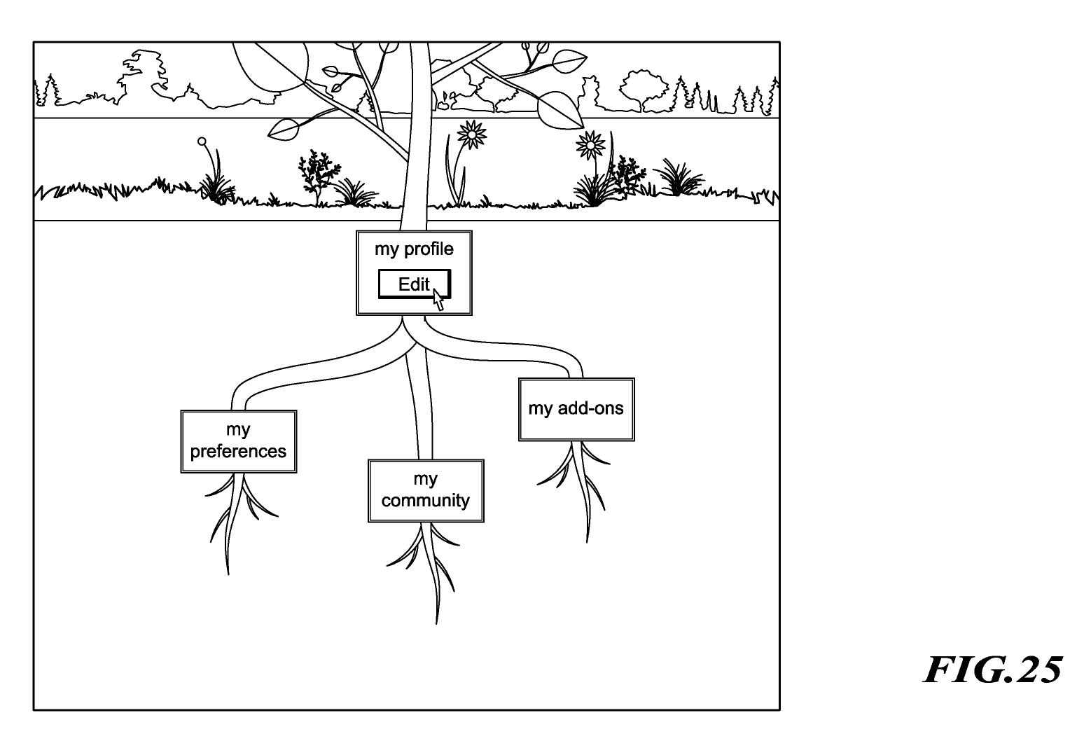

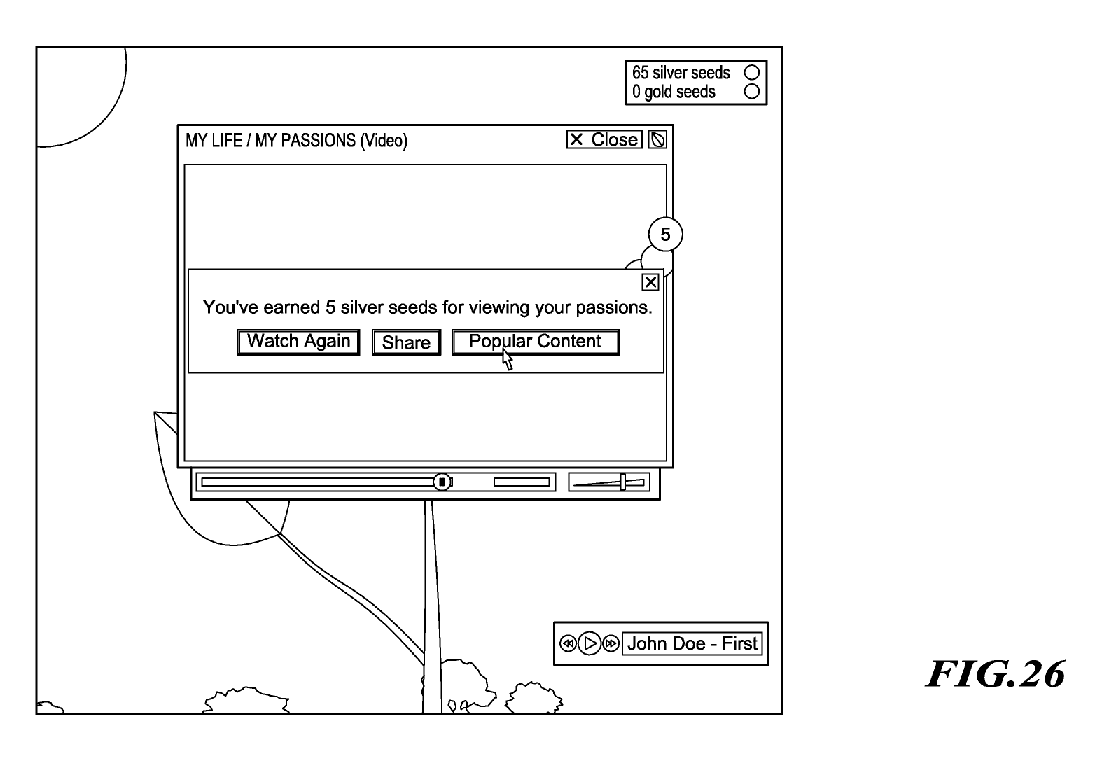

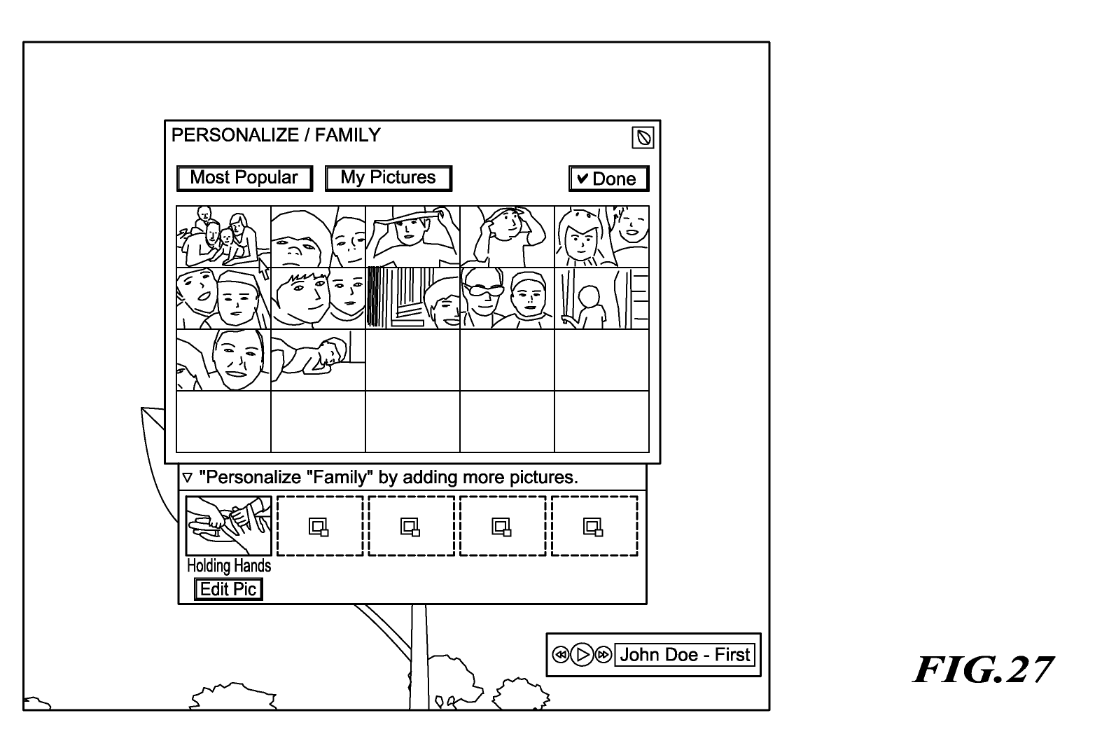

FIGS. 1-27 illustrate screenshots associated with and/or generated by one or more embodiments that may be provided, or otherwise facilitated, by the elements illustrated and discussed with reference to FIGS. 28-29.

A human lifetime consists of people, relationships, activities, goals, interactions, hobbies, aspirations and beliefs. As people pursue these endeavors, they utilize a wide variety of tools, systems, teachers and techniques. From Weight Watchers to Tony Robbins to Franklin-Covey to Nike to The Secret, millions of dollars and hours are spent in the pursuit of growth and self improvement. The present invention is a graphic representation of this world, a platform for exploring and discovering the resources to support those life areas. It's a way to be inspired, evaluate different approaches and connect with, collaborate and support like-minded individuals.

A user starts as a seed which grows into a young sapling. Unlike a typical webpage, the visual interface is a soothing landscape containing the central tree amidst a natural ecosystem the user can interact with. Trees in the distance represent other users. A butterfly lands on the tree when a friend sends a message. As the user adds life areas, the sapling matures into a tree with branches for each area.

At each branch, there is an application that the user interacts with to describe a part of their life. For example one branch could represent fitness. The application would help them set up goals, milestones, a practice schedule and a scorecard to measure their progress towards a fitness or diet objective. Another branch might represent something more intangible such as something for which they are grateful. This application would walk them through the assembly of a 30 second video that personifies or inspires them, using stock and personal images, audio and text. Branches can be kept private, shared with friends or made public.

Service providers can sponsor specific areas and integrate their content, methods or tools into an application. Weight Watchers might have a dieting app, Nike a fitness app, Deepak Chopra a spirituality app. The user community can extend or modify these applications. A user may create a family scrapbook application.

“My Life Tree” is the primary, stand alone application that would appeal to consumers who buy health and wellness products and services including personal growth products and services. These are purpose driven consumers who seek opportunities for personal growth, self discovery and/or mastery over life management.

COMMUNICATION & INTERACTION MODEL Alongside My Life Tree is a communication and interaction model consistent with the look and feel of the 2½ dimension UI. [Sidebar: the term 2½ D UI means that MySpace and Facebook are 2D web page UI and a Second Life or Eve are 3D Virtual World UI and this UI is a self contained UI that is somewhere between these two models. The purpose is to present a simple, elegant, luxurious user experience that is slightly different from what people are used to but not so alien as to limit the market potential but to entice users to explore and play with the user interface.] The communication model enables users to send messages back and forth, share with defined groups and make public broadcasts. Bridges and interfaces to Instant messaging, text messaging, email, audio chat and video will all be integrated. Most of the default communication modes enabled in a typical social network application will be enabled with enhancements that are described later in this document.

A third core element is the marketplace functionality. When a user creates a branch that represents some goal or objective, the interface will visually illustrate resources they could utilize to accomplish or manage that. These resources could be applications, books, DVDs, websites, seminars, or individual coaching supplied by an appropriately accredited coach (running coach, diet coach, life coach etc.). Users are introduced to relevant resources and can shop and evaluate these highly personal products/services in a trustworthy, comfortable environment. The marketplace includes:

1. Expert reviews and opinions

2. Self promotion by owners/authors

3. Wisdom of the crowd (popularity, reviews, testimonials)

4. Likeminded matching (“My Friends” or “People Like Me” affinity).

This would be a major innovation for this industry, which currently lacks standards or a reliable way to compare or evaluate. Making these resources visible, comparable and testable creates credibility and expands the attractable market for these products and services.

A fourth element is an economic incentive model that implements the best practices from multiplayer and casual gaming platforms. There are two currencies (Silver and Gold seeds) used that the user can spend and acquire. Silver seeds can be spent within the My Life Tree applications and within the interface to unlock features, to buy application services and to use to acknowledge other users. Users earn Silver seeds by investing in their tree, by completing milestones within applications and in exchange with other users. Gold seeds are purchased, rewarded from vendors, and provided as promotional incentives and can be redeemed for real goods and services within the marketplace.

These two currencies allow for real economic motivations to play out within the present application and the associated user community. The separate currencies are required to limit the fraud or hacking risks and to comply with banking regulations and national laws. These are well understood incentive models and techniques.

My Life Tree

Economic Incentive Model

Marketplace

Communication & Interaction Model.

This system combines a life visualization application, social networking elements, a marketplace and multiplayer gaming elements presented via a rich “forest ecosystem” interface. On its own this has some distinct appeal and would be an interesting Web 2.0 consumer application. For comparisons sake, the site 43things.com allows users to declare the 43 things they want to accomplish in life, meet up with like-minded people and interact with them. The site achieves more than 1.2 million unique visitors a month. The application of the present invention offers all these elements and much more in a more complete and attractive package.

Beyond this base there is a much larger marketplace of consumers without an online environment to serve them. These consumers spend their money on personal trainers, on self improvement books, on personal growth workshops, on life coaches and on time management programs. They represent a 10 billion dollar market that is growing at 11.4% per year. Many of the consumers of these products or services have an allegiance or affinity for some of the approaches developed by a set of service providers that includes Dr. Phil, Tony Robbins, Deepak Chopra, Landmark Education, LifeSpring, Martin Seligman, Wayne Dyer, Harv Ekhart and others. The graduate base of these vendors is well over 25 million people in the U.S. and more than 100 million globally.

A final layer or element implements the vocabulary, definitions, interaction rules, methods and techniques of these systems. The way the tree unfolds, the questions that are posed to the user along the way, the way the soil or the sun interact with the tree, the way communication with others is handled and the modes of interaction would all be shaped by the paradigm that the user has selected or defaulted into. There would be a Positive Psychology paradigm that is consistent with the detailed model described by Martin Seligman PhD, there would be another consistent with the Neural Linguistic Programming techniques of Tony Robbins, there would be another consistent with the spiritual methods of Deepak Chopra, and another consistent with the teachings of the Dali Lama. Users would be able to choose a paradigm they prefer or want to explore. This could be applied at the base level of their life tree or only on specific branches.

These paradigms will be created in partnership with those intellectual property owners and allows them to precisely describe the ecosystem consistent with their models. The purpose of this is to allow users to choose a model they have experience with and prefer or to allow users to compare and trial these models on their own terms. To the degree this system is successful at embodying those models the organizations can also bring their graduate/customer base to the system as a new online software forum to interact with and engage their loyal customers.

A typical new user with no paradigm affiliation will experience a richly graphic tool for describing their goals and aspirations and for sharing those with friends or the community, browsing others, and finding and interacting with like-minded people in the community. A paradigm affiliated user will experience the same but consistent with the rules and models of the paradigm. The present invention provides the basic tools to support their purpose directed objectives and to help them learn about useful alternative approaches and leverage the graduate and customer bases of these existing communities by giving them a place to come and manifest their model.

Paradigm Layer

My Life Tree

Economic Incentive Model

Marketplace

Communication & Interaction Model

The present invention packages a set of proven technologies and approaches with a life visualization application and user interface to addresses the needs of purpose driven consumers. The marketplace tools provide an excellent lead generation platform for service providers like Tony Robbins, Deepak, Landmark Education, or Dr Phil. It also broadens the market by providing a neutral marketplace that allows potential customers to safely explore these approaches on their own terms and discover models, products, services that would support what they want to be up to.

A successful result for this vision would be a service with 4-8 million active monthly users, a half dozen or more paradigms implemented, hundreds of applications, thousands of vendors and service providers and a few hundred thousand monthly marketplace transactions within 3-4 years. That user base would be built by winning over users of 43things.com and a few similar websites, and by engaging the paradigm owners to bring their loyal customer bases to the service in exchange for the lead generation the system provides to their businesses.

Self-improvement is boring. The present invention makes it entertaining. It is a media-rich self-improvement platform that meters in concepts of positive psychology and self-discovery in a way that improves people's lives while they are entertained.

The present invention is a “living” media platform that contains two major components: Life Tree and Mindbloom World. The Life Tree is a customizable interface for discovery, visualization, and growth in any area of life. The core components of the Life Tree include:
Quests Module—Quests are interactive “mini-games” that guide and reward users through the process of discovery, inspiration, and growth. Users who engage in quests will be rewarded with Mindbloom “seeds.” Seeds are used to unlock additional Mindbloom content & features, discounts on sponsored products & services, as well as boost the user's online reputation rating. Quests can be played by multiple people (or teams), both cooperatively or competitively. Quests will be represented visually as individual blooms on the Life Tree.
Discovery Module—Users increase awareness and knowledge through interactive “discovery modules” that may include visual and audio explorations, awareness interactives, and knowledge feeds.
Visualization Module—This is where users choose, create, share and/or export visualizations (fully customizable videos that combine the evocative images, music, and words selected by the user during the discovery process). Visualization content will be represented visually as leaves on the Life Tree.
Growth Module—This is where users take “real-world” action on a quest by selecting or creating on-line and/or off-line activities/challenges, set/track goals, and measure their progress and level of gratification.

The Mindbloom World is the user interface for sharing and connecting with friends, family, community, personal coach, and/or Mindbloom partners/sponsors. The core components of the Mindbloom World include:
Social Support System—The social support interface allows friends, family, community, and Mindbloom partners/sponsors to support a user by sending them encouraging text messages, evocative multimedia content, premium Mindbloom content, or engaging and relevant interactive advertisements with links to high quality products, services, and information. Each piece of content sent to a user may be visually represented as various ambient life (birds, butterflies, flowers, etc.) surrounding the user's Life Tree.
Neighborhoods—Using a secure permission system, users can search the Mindbloom World for the Life Trees of their friends, family, community, and/or personal coach and add them to their virtual neighborhood for easy access.

The initial experience is not only compelling enough for a user to want to continue coming back, but that they will want to tell someone else about it. Therefore the experience includes:

Simple (interface)

Evocative (content)

Rewarding (experience)

Special (unique).

Below is a walkthrough (images pending) of what an example initial experience may be like:

Registration—Use an engaging & visual method for getting information

See the mindbloom world (3D globe)

Enter a zip code or click on the location in the world (see location of other users)

Choose age by clicking on the rings of a cut log

Discover images, music, and text—grow life tree

Watch life vision—in bloom

Share life vision with a friend

Export life vision to portable media device

Choose a life action
Be reminded of action
Complete action
Measure gratification
Give a seed to a friend
See your friend's tree begin to grow
Each day the life vision grows with new content
Choose a new quest
Choose a “specialized” visualization
Choose a set of challenges to play with someone else
Monitor your progress
What your tree grow

The Life Tree is a customizable interface for discovery, visualization, and growth in any area of life. The core components of the Life Tree include:
Quests Module
Discovery Module
Visualization Module
Growth Module
Quests Module

Quests are interactive “mini-games” that guide and reward users through the process of discovery, inspiration, and growth. Quests will be represented as individual blooms on the Life Tree.

New users will always begin with the initial “Life Quest” where they will discover media content that represents what they are grateful for, what their character strengths are, what their passions are, what their dreams are, what their aspirations are, and ultimately their purpose. This discovery process will automatically create a fully customizable life vision that can then be personalized and shared. The user will then have the option to simply track their progress in growing their overall happiness.

As the user engages in the “Life Quest”, they will be awarded seeds that allow them to unlock new quests or create their own. Quests can be created for any Area of Life.

The present invention allows users and the community to create custom quests. These quests will be created from various templates that range in functionality. For example, the most basic custom quest may be just allowing the user to choose/create an action for the day and track whether they did the action and how gratifying it was when they performed the action. A more advanced custom quest may allow a user to create specialized visualizations and do advanced tracking of goals.

Partners and sponsors associated with the present invention will have the tools and documentation to create premium quests that may have a totally unique interface as well as content. Premium quests may award users with “trophies” as well as potential discounts on products & services.

A multiplayer quest is a quest that multiple users or groups can do cooperatively or competitively. Shared multiplayer quests are quests where users can share their progress with other users on the same quest. Cooperative multiplayer quests may have a set of challenges that users can assign to themselves or each other with dependencies, target completion dates, and measurable goals. Cooperative quests can request input from other players to assess someone's progress.

Competitive multiplayer quests are typically a series of repetitive or unique challenges that each user agrees upon. The win scenario requires users to agree on a target completion date as well as measurable goal. Competitive quests can request input from other players to assess someone's progress.

Users who engage in quests will be rewarded with “seeds.” Seeds are used to unlock additional content & features, discounts on sponsored products & services, as well as boost the user's online reputation rating.

Silver seeds are earned by growing the Life Tree and supporting the community. Gold seeds are purchased. Special features and content may require a combination of silver and gold seeds to be unlocked.

As noted above, silver seeds are earned by growing the Life Tree and supporting the World (i.e. community). As a user earns silver seeds in a particular Area of Life they can reach different levels of reputation in that particular Area of Life. For example, someone may go from the level of “Beginner” to the level of “Guru” by earning enough silver seeds over time. Also, if a user participates in supporting the community by creating content or by directly helping others, then they may be awarded silver seeds from the individual person that was helped. These community earned silver seeds will increase the user's reputation level as a “Guru” community contributor. The reputation system is not only a mechanism for “showing off”, but most importantly it is a system for users to weed out other users who have a weak reputation; thus improving the overall experience.

Users increase awareness and knowledge through interactive “discovery modules” that may include:
Visual and Audio Explorations
Awareness Interactives
Knowledge Feeds

Visual and Audio Explorations.

The user is given the opportunity to explore visual and audio content in a uniquely engaging way that helps them personalize their experience as well as discover more about where they want to grow in life. These explorations are basically enhanced interactive slide shows. They are designed to evoke emotion and trigger aspirations that are hidden deep inside all of us. The first time a user is given the option to go on an exploration, they may be asked to provide more information about themselves to ensure they are not given images or music that is incongruent with their lifestyle or tastes.

Visual and audio content is provided and is sorted and filtered by popularity, relevance, price, etc. (See Content Strategy for more information).

The user may be given the opportunity to take simple and thought provoking assessments to become more aware about where specifically they want to grow in any Area of Life. These assessments can also be re-taken periodically to show measured growth.

The user may be given the opportunity to read information or watch video streams that are of high quality and relevance to any Area of Life the user is currently trying to grow.

Select registered users will have access to an expanded view of the Life Tree and be asked to participate in feedback and discussion about the Tree metaphor and interaction

Users can register and enter a daily challenge (simplified): An email will be sent to them as a reminder and opportunity to view another Visual and Audio Exploration.

Free or Premium Discovery Add-Ons: Discovery add-ons allow users to receive discovery content created and/or recommended by friends, family, community, and sponsors/partners. Some premium discovery content may be released as teasers. Users can then purchase the full discovery packs with Silver and/or Gold seeds if and when they choose.

A Visualization Module is where users choose, create, share and/or export visualizations (fully customizable videos that combine the evocative images, music, and words selected by the user during the discovery process). Visualization content is represented as leaves on the Life Tree.

All visualizations are primarily meant to be evocative and meditative to increase user retention, creativity, and most importantly to increase user motivation to take action.

There are at least two types of visualizations:
Aspirational Visualizations
Transformative Visualizations

Aspirational visualizations use images, music, and text to create a specific vision of what the user aspires towards.

Transformative visualizations use images, music, and text to increase knowledge, provide a new perspective, and/or potentially heal body, mind, & heart.

Visualization content is provided, its partners/sponsors, or the community. Some specialized visualizations may simply be video streams to existing content on the web (e.g. a relevant YouTube video, an inspirational movie trailer, etc.)

In one embodiment, Visualization Viewing has the ability to view Flash videos that utilize still imagery, music, and text. (view below)

In another embodiment, Visualization Viewing has the ability to view Flash videos that utilize still imagery, music, and text. These videos also should have full screen support and panning/zooming support. This feature also needs to support the viewing of existing video streams from other web sites.

Visualization Browsing provides the ability to browse for other visualizations from a library as well as inserting new video streams.

Visualization Customization provides the ability to customize visualizations (remixing of images, music, and text) as well as allow users to upload personal images, music, and/or text to create custom visualizations. This feature will need to be investigated further for technical feasibility.

Customization would also include basic photo editing features such as de-saturation (B&W), automatic image quality correction, cropping/scaling, colorizing, and image panning/zooming.

Visualization Reviews and Recommendations provide the ability to individually rate the quality of images, music, and/or text in each visualization to allow new content to be personalized to the user's likes and dislikes.

Visualization Compilations allow existing content on the Life Tree (e.g. individual branch, group of branches, or the entire tree) to be quickly viewed as a single visualization. For example, by choosing to watch a visualization compilation of the entire Life Tree, the present invention can intelligently grab a subset of images from the Life Tree and apply them to a visual theme and synchronize all the content to a selected song. These visualization compilations can then be viewed, saved, exported to a portable media device, or shared with others. These visualization compilations may be unique each time it is viewed (by randomly picking new images or music) depending on the user's preferences and the amount of content on the current Life Tree. As the user watches any visualization compilation on the computer (from the website), they will be given the ability to click a button during playback to tag specific content to never be used or always be re-used for future compilations.

Image Purchasing provides the ability to easily browse and purchase images from a single library composed of local server content and content from various stock photo sites. (e.g. iStockPhoto.com)

Music Purchasing provides the ability to easily browse and purchase music from a single library composed of local server content and links to content from various partner sites (e.g. Amazon-mp3.com).

Text Purchasing provides the ability to easily browse for and purchase text customized for visualizations. Texts may include famous quotes as well as excerpts from published books (this will require partnerships with book publishers and authors).

Free or Premium Visualization Add-Ons allow users to receive customizable visualization content created and/or recommended by friends, family, community, and sponsors/partners. Some premium visualizations may be released as teasers. Users can then purchase the full visualization packs with Silver and/or Gold seeds if and when they choose.

Mindbloom Screensaver provides the ability to add visualization content to a Mindbloom Screensaver.

Mindbloom Plug-In allows one to create a plug-in that allows user to easily tag and store images, text, links, and or songs for future use.

A Growth Module is where users take “real-world” action on a quest by selecting or creating on-line and/or off-line activities/challenges, set/track goals, and measure their progress and level of gratification.

A challenge is a unique action or set repetitive actions that a user specifies to grow in a particular Area of Life. A challenge can even be as simple as a link to another on-line site (e.g. WeightWatchers.com or Active.com) where they go to take action. Based on the user's profile or preferences, challenges may have multiple options that the user can choose to achieve the intended outcome. For example, the user may be challenged to do something romantic for their spouse. The user can then be given a limited set of challenges to pick from, with some challenges being more practical than others.

Users can set goals with a target date of completion and measurable completion.

Users will have the option to journal their progress as well as indicate the level of gratification they received at any point during their growth.

Experience Tracking—After the completion of any action (i.e. create a bloom), the user has the option to enter notes and/or attach an image or link to document their experience. The user may also be provided with some rating mechanism for rating the quality of their action and the amount of gratification they received from performing the action.

Free or Premium Quest Add-Ons allow users to receive quest content created and/or recommended by friends, family, community, and sponsors/partners. Some premium quest content may be released as teasers. Users can then purchase the full quest packs with Silver and/or Gold seeds if and when they choose.

The following is a list of miscellaneous Life Tree features.

Free or Premium Add-On Packs allow users to receive a complete set of discovery, video, and quest content created and/or recommended by friends, family, community, and sponsors/partners. Some premium add-on packs may be based on popular books or other online programs and then released as teasers. Users can then purchase the full add-on packs with Silver and/or Gold seeds if and when they choose

Tree Journaling/Blogging allow users have the option to journal their growth and share it with others (blogging).

A Quest Notification System is a system for enabling e-mail notifications to be sent to yourself and/or network of friends or family regarding the status of current quests.

Users can set the rate at which new content and opportunities are made available to prevent the user from being “overloaded.” This gives users the option to have an experience ranging from 5 minutes a day to 30 minutes a day.

Tree Search is a system for users to search for specific content on their Life Tree by keyword, Area of Life, type, and date range. This feature may also be used as an alternate method for accessing daily content in a more typical web interface format (e.g. content sorted in lists).

Tree Filtering is a system for users to quickly filter out content from their Life Tree by Area of Life, type, and date range. This feature can also be used to make a more developed Life Tree be more manageable to interact with. For example, a user can virtually start fresh each year by filtering out all previous years of growth. However, users still have the option to view the entire Life Tree at anytime by turning off the Tree Filter.

With Time Lapse, users can quickly replay the growth of their Life Tree by using the time lapse feature. Similar to a time-lapsed video, the user will see their original seed grow and bloom into a tree in only seconds.

Gadget and Widget provides the ability to give or get updates and content via Microsoft® gadgets or Macintosh® widgets.

Surrounding the Life tree is an immersive environment intended to “emotionally center” (i.e. relax) the user. These environments may represent real-world and/or fictional locations.

Dynamic Scenery may be provided (e.g. animals, people, vehicles, etc.).

A system for displaying real time of day by changing the position of the sun and moon and the ambient light of the environment may be provided. Users will have the option to disable this feature.

Weather System is a system for displaying either real time local weather or “mood” weather by changing the weather in the virtual environment.

Environmental Audio is a system for playing ambient sounds/music. This system would have volume fade support for when users interact with other features that have sounds/music.

Music Streaming has the ability to stream a playlist of favorite music instead of ambient music.

World is an interface for sharing and connecting with friends, family, community, personal coach, and/or partners/sponsors. The core components of the World include:

Environments

Neighborhoods

Social Support System.

The Social Support System allows friends, family, community, personal coach, and partners/sponsors to support a user by sending them encouraging text messages, evocative multimedia content, premium content, or engaging and relevant interactive advertisements with links to high quality products, services, and information. Each piece of content sent to a user may be represented as various ambient life (birds, butterflies, flowers, etc.) surrounding the user's Life Tree.

Social Support Interface includes additional ambient life with additional style variations, special FX, and animations.

Neighborhoods provides using a secure permission system, users have the ability to search for the Life Trees of their friends, family, and/or community to their virtual neighborhood for easy access.

Neighbor Find is a system for users to quickly and easily locate the Life Trees of friends, family, and/or the community to add to their virtual neighborhood. This search can be done with name, user name, or e-mail address.

Neighbor Share is a permission/sharing system that limits who is able to access and view someone's Life Tree and what specific branches of content users can view. Specific pieces of content and/or types of content on the Life Tree can have individual permission settings as well.

### APPENDIX A

Areas of Life

Meaning

Living

Your purpose

Giving

Time, money, or your talent/passion

Connecting

With a higher power

Health

Physical

Fitness

Nutrition

Healing

Mental

Hope

Presence

Fitness

Healing/Forgiveness

Heart

Gratefulness

Giving

Healing/Forgiveness

Finances

Money

Security

Recreational

Retirement

Generational

Security

Wills

Insurance

Health

Property

Romance

Communication

Intimacy

Sex

Family & Community

Raising Children

Newborns

Toddlers

Pre-teen

Teenagers

Building Relationships

Children

Friends

Relatives

Peers

Life Events

Planning for a Birth

Planning for an Adoption

Planning for a Wedding

Dealing with Separation/Divorce

Dealing with Illness (self or friend/family/peer)

Dealing with Death (friend/family/peer)

Education & Career

Education

Career Building

Organization

Communication

Leadership

Recreation

Experiences (Travel & Adventure)

Sport (Golf, Fishing, Baseball, etc.)

Creative (Music, Art, Dance, Acting, Writing, etc.)

Entertainment (Books, Games, Movies, etc.)

Lifestyle

Homes

Vehicles

Fashion

Toys & Accessories

### APPENDIX B

Content Strategy

The present invention purchases and/or creates the content to build the initial image, music, and text libraries to create a compelling enough experience that will seed the beginnings of a large community of users. Once we have a large enough community, the present invention builds partnerships with content providers, sponsors for “premium” content and the community for “fresh” content.

Appendix C

Positive Psychology

Below is a summary of the proven principles of Positive Psychology and how Mindbloom anticipates incorporating these principles into its online experience.

Summary of the Positive Psychology Principles

Implementation of Positive Psychology

Mindbloom's Implementation of Positive Psychology

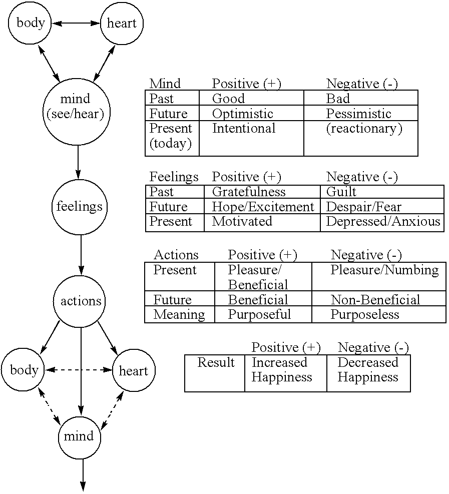

### APPENDIX D

### Potential Partners and Sponsors

Below is a preliminary list of potential partners and sponsors.
Nike®—Fitness, Sports, Recreation
Expedia®—Travel
Dr. Oz®—Nutrition

### APPENDIX E

### Technology Overview

### Technical Flow

A fractal data loop is the best method for replicating the branch, leaf and bloom cycle.

Step 1: The user begins with a juvenile trunk and one leaf bud.
User clicks the bud
The system pulls first 8 options related to the current level (first view options based on 8 areas of life—Appendix A)
User chooses one
Zoom in on leaf as it matures and branch extends

Step 2: User watches Visual & Audible feature
Licensed, user-generated, or custom flash video plays
When complete, the camera zooms out to reveal whole tree (or possibly parent branch)
Bud forms next to the leaf they just experienced

Step 3: User takes action
User clicks the bloom bud
Zoom in on bud to see options for taking action
Enter/select action, enter email, submit
Zoom out
Parent branch extends to provide option to either start a new fork, or continue on the same branch to narrow down the scope of that topic.
Repeat

### Data Architecture

Data organization and retrieval is based upon on a taxonomical structure. This provides a very consistent order for both local server and user-generated content.
Options given at each decision point in the tree are based on a narrowing of the search criteria. Example: A, A.1, A.1.1, A.1.1.1, etc.
A new fork is formed by returning and adding a choice at any node. The result is that at A. 1.1 a new branch would form looking like A, A.1, A.1.2, A.1.2.1, etc.

### User Interface Technologies

The experience will be built upon the most current versions of:
Adobe Flash
Adobe Flex
Adobe Integrated Runtime (AIR)

### Media and Information Architecture

PaperVision 3D—A high performance 3D engine for Flash 8 & 9. Features linear texture mapping, optimized for rendering speed and quality. More information is available @ http://blog.papervision3d.org/

Red5—Red5 is an Open Source Flash Server written in Java (http://osflash.org/red5) that supports:
Streaming Audio/Video (FLV and MP3)
Recording Client Streams (FLV only)
Shared Objects
Live Stream Publishing
Remoting

### Server Platform

LAMP—Linux, Apache, MySQL, and the use of one or more dynamic languages such as Python or Ruby.

Ruby on Rails, Django with SQLAlchemy and Mochikit, (or similar)

Java EE (for Java application support)

XML, XSL, XSLT

### APPENDIX F

### Reference Images

Example of Graphs—Nike+

### APPENDIX G

The user has the option to also drag any flowers from friends, the community, or partners/sponsors to their life tree. If it is visualization content, it will be added as a leaf If it is quest content, it will be added as a bloom bud. It may also be general knowledge information about products/services that earn the user free content (i.e. music, image, and/or text) if they engage with the interactive ad.

The user can added journal entries to any leaf and/or blooms.

Any content on the trees (leaves or blooms) can be private, shared with friends, or public to the World.

When in the World view, the user can use keyword search to find trees that they want to view and “pick” content from. The leaves and blooms that are viewable will be color-coded to indicate them as private or public. Users have the option to add the “picked” leaves and or blooms to their own tree. If the leaf or bloom content requires seeds to be purchased, then the user will have to have enough seeds to add the content to their tree.

Flowers that are planted below a user's tree may also have content that may require purchasing with seeds in order to add them to their tree.

Users can subscribe to flowers that show up each day with newly recommended visualization and/or bloom content. Users can choose from a list of content sorted by relevance, user review, reputation of creator, etc. Community members who create “mindblooms” that get good reviews, will be rewarded with seeds (silver and/or gold) as well as a boost in their “online reputation.”

Users can be rewarded with product/service discounts or free gifts if/when they complete partner sponsored quests.

Search the World for Trees
Find a friend, family, or peer tree.
Find a “similar interest” tree.
Find a tree that wants support. (User may request only users who meet certain requirements)
Find corporate trees.
Find community trees.
Find most popular trees.
Find funniest tree.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method implementable in an electronic device, comprising the steps of:
providing to a first computer a graphical user interface enabling a user of the first computer to establish and monitor progress towards a personal objective; and
receiving data input from the user.

2. A computer-readable medium including instructions that, when executed by a processing device, enable the processing device to perform the steps of:
providing to a first computer a graphical user interface enabling a user of the first computer to establish and monitor progress towards a personal objective; and
receiving data input from the user.

3. A system, comprising:
at least one electronic device configured to provide to a first computer a graphical user interface enabling a user of the first computer to establish and monitor progress towards a personal objective, and receive data input from the user.
